(19) United States
(12) Patent Application Publication
(10) Pub. No.: US 2026/0268795 A1
(43) Pub. Date: Sep. 10, 2026

(54) SYSTEMS AND METHODS FOR PROVIDING EDUCATIONAL INFORMATION

(71) Applicant: D2L Corporation, Kitchener (CA)

(72) Inventors: John Baker, Kitchener (CA); Kenneth Chapman, Kitchener (CA)

(21) Appl. No.: 19/660,499

(22) Filed: Apr. 28, 2026

Related U.S. Application Data
(63) Continuation of application No. 18/243,925, filed on Sep. 8, 2023, now abandoned.
Application No. 18/243,925 is a continuation of application No. 14/629,020, filed on Feb. 23, 2015, now abandoned.

(51) Int. Cl. G09B 19/00; G06Q 50/20; G09B 5/02

(52) U.S. Cl. CPC G09B 19/00; G06Q 50/2053; G09B 5/02

(57) ABSTRACT

The embodiments herein relate to electronic learning (“eLearning”) systems and methods. The systems include at least one server, a plurality of computers in data communication with the at least one server, the computers being usable by educational providers, learners, employers and accreditors to connect to the server, wherein the server is configured to receive educational provider information from the educational providers, the educational provider information for each of the educational providers including learning opportunity information associated with at least one learning opportunity.

### TECHNICAL FIELD

The embodiments herein relate to information systems, and in particular to systems and methods that provide educational information.

### CROSS-REFERENCE TO RELATED APPLICATIONS

This application is a continuation of US Application No. 18/243,925 filed September 8, 2023 which claims the benefit of U.S. Patent Application No. 14/629,020 filed on February 23, 2015. The entire contents are hereby incorporated herein by reference for all purposes.

### INTRODUCTION

There are thousands of educational providers around the world that offer learning opportunities. These educational providers may be universities, colleges, private institutions, and the like, who may offer hundreds or even thousands of different learning opportunities. These learning opportunities include for example classes, seminars, webinars, and other learning events.

Educational providers normally publish a course calendar and/or a course catalog that includes information about various courses or other learning opportunities that the educational provider offers. Typically, an educational provider will publish the course catalog or other course information on a website associated with the educational provider in addition to (or instead of) providing hardcopies of this information.

This course information is often published at different virtual locations (e.g., at different websites). Thus a prospective learner looking for a particular course may need to visit a number of different websites to locate a learning opportunity that is of interest to the learner. Accordingly, the learner may need to expend a significant amount of effort to obtain information about the available learning opportunities.

Furthermore, it is possible for a learner to remain unaware of some educational opportunities despite conducting research about the educational opportunities that are available. For example, information about the educational opportunities offered by non-traditional educational providers (e.g., entities other than universities and colleges, such as those offered by private institutions) may not be known to a prospective learner. It is also possible that the learner may not know where to look to receive information about the various educational opportunities that are available.

Moreover, a learner may be unaware that some educational opportunities are equivalent in that they provide similar skills and knowledge. For example, a learner may be unaware of a less expensive or a more convenient alternative learning opportunity that may be available to the learner.

In many cases, a learner may be motivated to upgrade his or her skills to achieve an objective. For example, a learner may be looking to upgrade his or her skills to qualify for a promotion or for a different job position. This may be related to a lateral or vertical transfer. In another example, a learner may be looking to take courses to obtain accreditation or certification from an industry body. However, a learner may not know the particular skills that are needed to obtain a desired employment position or type of accreditation. Furthermore, the learner may not know what learning opportunities are present to obtain the needed skills.

From the perspective of educational providers, educational providers are often unaware of a demand for a particular learning opportunity. For example, if there are a number of learners who desire that a particular learning opportunity be offered at a particular location (e.g., the city or town where the learners are located), it may be worthwhile for an educational provider to offer that learning opportunity at that location. However, as the learners tend to make decisions independently, the educational providers may not have an opportunity to gauge the amount of interest in having the particular course at that location, which may inhibit the course from being offered.

### BRIEF DESCRIPTION OF THE DRAWINGS

Various embodiments will now be described, by way of example only, with reference to the following drawings, in which:

FIG. 1 is a schematic diagram of a learning system according to some embodiments;

FIG. 2 is a schematic diagram illustrating how various users may interface with the learning system shown in FIG. 1;

FIG. 3 is a schematic diagram illustrating an example of a learning-opportunity profile based upon the educational provider information;

FIG. 4 is a schematic diagram illustrating an example of an employment position profile associated with one or more employment opportunities based upon the employer information;

FIG. 5 is a schematic diagram illustrating an example of an accreditation profile associated with an accreditation, based upon the accreditation information received;

FIG. 6 is a schematic diagram illustrating an example of a learner profile 150 associated with a learner that may be generated by one or more processors of the system 10 based upon the learner information received; and,

FIG. 7 is a flow diagram illustrating a method for providing education information.

### DETAILED DESCRIPTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

In some cases, the embodiments of the systems and methods described herein may be implemented in hardware or software, or a combination of both. In some cases, embodiments may be implemented in one or more computer programs executing on one or more programmable computing devices comprising at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

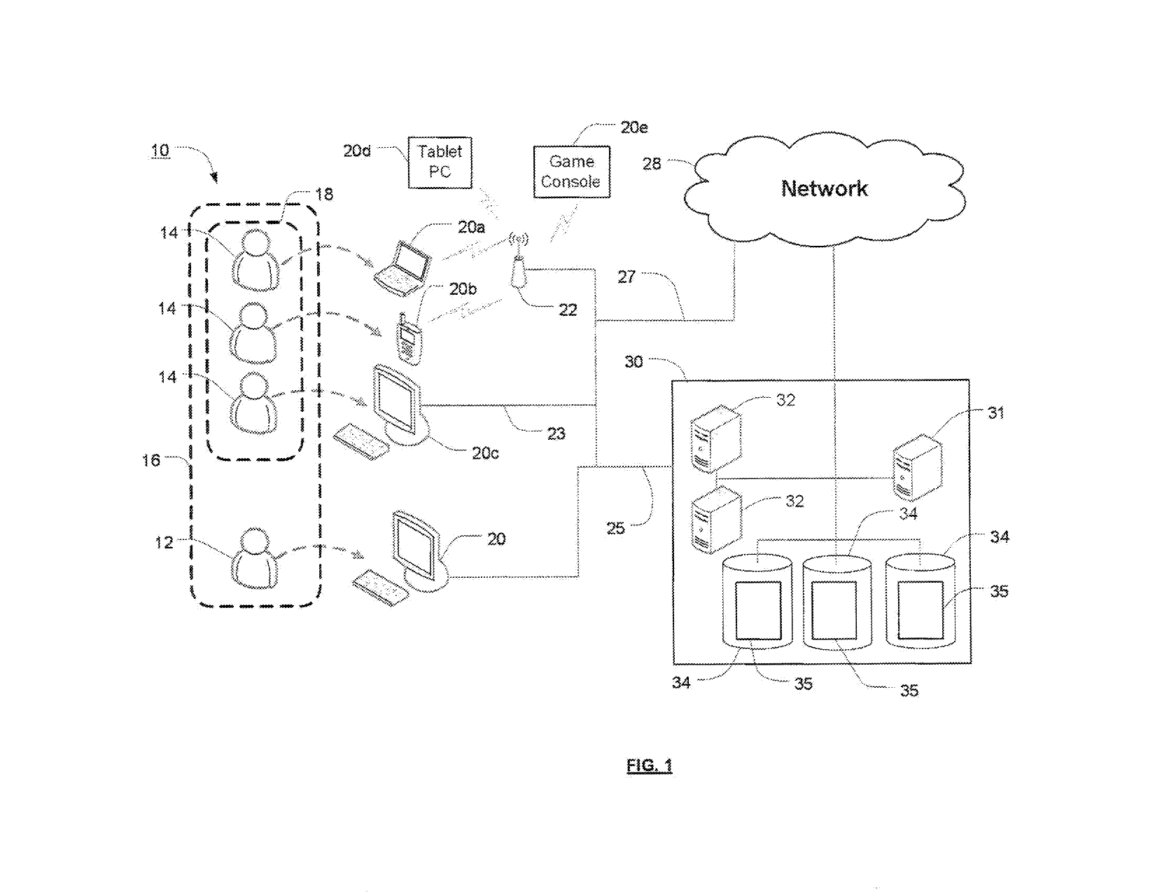

Referring now to FIG. 1, illustrated therein is an educational information system 10 for providing an electronic learning network. The system 10 includes a plurality of computing devices 20. The computing devices 20 may be used by various users 14 to access and participate in the learning network.

The computing devices 20 are electronic devices that include one or more hardware data processors that can be used to access one or more servers 31. The computing devices, for example, include laptops 20a, a personal digital assistant (PDA) 20b or smartphone, a personal computer 20c or terminal, a tablet computer 20d and a game console 20e.

The devices 20 may access the learning network over a data network 28, which for example may be the Internet. The devices 20 may include suitable networking hardware (e.g. modems) to access the learning network. In some cases, the connection between one or more of the devices 20 and the network 28 may be wireless, for example, through a wireless access point 22. In some cases, the connection between one or more of the devices and the network 28 may be wired.

The computing devices 20, in some cases, may have dedicated software installed therein to participate in the learning network. Alternatively, the learners 14 may access the learning network sing a web-browser application through a web interface on the devices 20a-20e.

The computing devices 20 are usable by various users, such as users 12 and 14 in a network 16 to access the learning network.

The users 12, 14 may include educational providers, learners, employers, accreditors, and other suitable parties. It should be understood that the users 12, 14 may be employees of various entities, or in some cases, one or more computer system acting for the entities (e.g. an entity such as an educational provider may automatically upload information to the system automatically).

In some cases, a same user may have more than one role within the learning network. For example, employers may also be acting as accreditors or educational providers. That is, a user 14 from an entity (e.g., Microsoft Inc.) may interact with the learning network in the role of the employer by providing employer information. The same user or another user from the same entity (i.e. Microsoft Inc.) may also interact with the learning network in the role of the educational provider by providing educational provider information (e.g., classes held by or organized by Microsoft Inc.). The same user or another user from the same entity (i.e. Microsoft Inc.) may further interact with the learning network in the role of an accreditor by providing accreditation information (e.g. Microsoft Certified Professionals).

Each of the users 14 may have a user account associated with the user. The user account may be used to identify the user to the system 10. A user account for a human user, for example, may be assigned a user name that is based upon the first and last name of the user. A user account for a non-human user may be assigned a username based upon the entity associated with the user. Non-human user accounts may facilitate batch upload of information by some other system (e.g. the information technology system of an educational provider and/or an employer) to the learning network .

A user account may have one or more user roles assigned thereto. The user role may determine how they will interact with the learning network, for example, as a learner, educational provider, accreditor, employer, etc. In some embodiments, the user may be able to switch between roles after the user has authenticated himself or herself to the system such that multiple login information or user accounts are not necessary. Switching between roles may allow the user to interact with different interfaces provided by the system 10. For example, when the user is in a learner role, the user may interact with a learner interface for the system 10. But when the user switches to an employer role, the same user may interact with an employer interface from the system 10.

The system 10 in this embodiment includes servers 32. Each of the servers 32 may include one or more hardware processors configured to provide the learning network as described herein. For example, the servers 32 may include hardware computer processors such as processors produced by Intel Inc. or AMD Inc. The servers 32 are configured to send information (e.g. electronic files such as web pages) to be displayed on one or more computing devices 20 in association with the learning network. In some embodiments, a server 32 may be a computing device 20 (e.g. a laptop or personal computer).

The servers 32 may be operatively coupled to more data storage devices 34 (e.g. memory, databases, etc.). The data storage devices 34 may be configured to operate as a relational database (such as a SQL database), or any other suitable format for efficiently storing and providing access to large volumes of data. The data storage devices 34 are configured to host data 35 about various components of the leaning network.

In some embodiments, the system 10 may also have one or more backup servers 31 that may duplicate some or all of the data 35 stored on the data storage devices 34. The backup servers 31 may be desirable for disaster recovery purposes (e.g. to prevent undesired data loss in the event of an event such as a fire, flooding, or theft). In some embodiments, the backup servers 31 may be connected to the servers 32 and the data storage devices 34 to perform periodic backups but located at a different physical/geographical location.

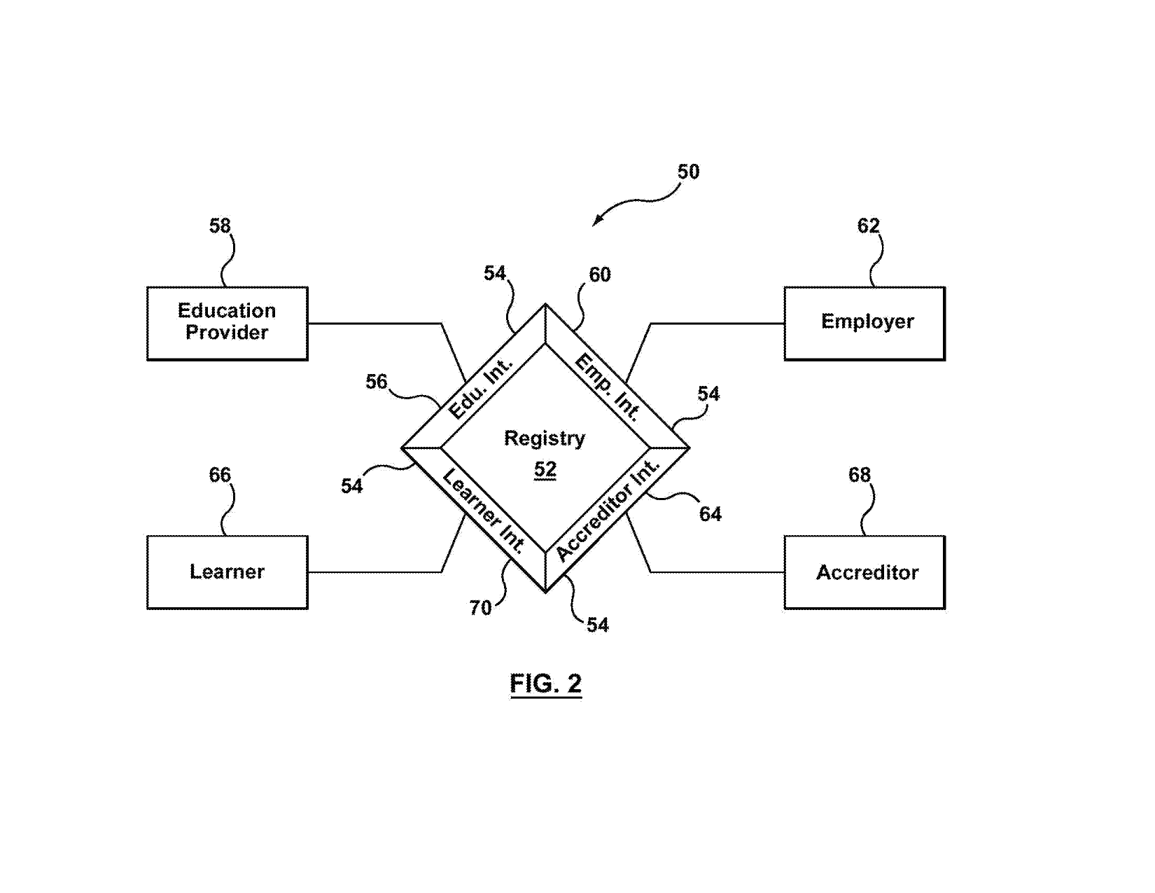

Referring now to FIG. 2, illustrated therein is a schematic diagram illustrating a plurality of modules 50 of an exemplary implementation of the learning network 12. One or more processors of the system 10 may be configured to provide the modules 50 shown in FIG. 2. For example, the server 32 may be configured to provide the modules. In another example, a combination of the server 32 and one or more of the computing devices 20 may be configured to provide the modules 50. It should be understood that the modules 50 are provided for exemplary purposes. In other embodiments, the functionality provided by the modules 50 may be implemented using different configuration of modules or not using any modules at all.

The modules 50 include a registry 52 where information provided by various users is stored. The registry 52 may be implemented for example by one or more of the data storage devices 34. The data storage device 34 may be implemented as a database (e.g., a relational database) to improve efficiency.

The modules 50 also include a plurality of interfaces 54. Depending on the desired interaction with the learning network, the users 14 may select one or more of the interfaces 54 to interact with the learning network 12. Each of the interfaces 54 is configured to provide functionality suitable for the appropriate user role as described below.

The interfaces 54 include an educational provider interface 56. The educational provider interface 56 is configured to receive educational provider information from one or more users 14 who are educational providers 58. The educational providers 58, for example, may include colleges, universities, professional bodies, consultants, and/or any other entity that provides learning opportunities. In many cases, traditional educational providers such as colleges or universities, who in addition to their on-campus learning opportunities, may wish to provide on-line learning opportunities as an additional revenue stream.

The educational provider information includes learning-opportunity information about various learning opportunities being offered by one or more of the educational providers 58. The learning opportunities may be a single event or a number of events. For example, a learning opportunity may be a single class or a number of classes. The learning opportunities may be offered on a recurring basis, as a single “one-off” occurrence, or made available upon demand. Examples of learning opportunities include classes offered by community colleges, universities, and accreditation bodies (e.g., CMA/CGA/CA). Learning opportunities may also include professional development classes such as one-off events offered by consultants/experts in a specific field.

The location of the learning opportunities may vary. For example, a learning opportunity may be held in a specific physical location and/or be held virtually over the Internet. For example, learning opportunities may be a weekend class at a local college or a webinar that is being conducted online. The learning opportunity information may include the location of the learning opportunity that is being offered.

The learning opportunities may also have an associated cost. The cost of the learning opportunities may differ between different learning opportunities that offer similar skills or even between different occurrences of the same learning opportunity. The learning-opportunity information may include the cost of the learning opportunity that is being offered.

The information provided by the educational providers may also include a description of the education/training being offered by the learning opportunity. The learning opportunity information may include the description of the learning opportunity that is being offered.

In some cases, the educational providers may specify the skills/knowledge/information being offered by a given learning opportunity. However, in other cases, the educational provider may not specify such information. In those cases, it may be possible to obtain the topics being taught or the skills being offered and/or information being presented by the learning opportunity from the description of the learning opportunity.

For example, a natural language analysis may be performed to the description of the learning opportunity to obtain non-trivial keywords from the description. These keywords may then be cross referenced against a master list of keywords to determine the keywords that are referring to the skills and knowledge being offered by the learning opportunity.

In some embodiments, a learning opportunity profile for each (or a number of similar learning opportunities (e.g., if the learning opportunity is recurring) may be generated.

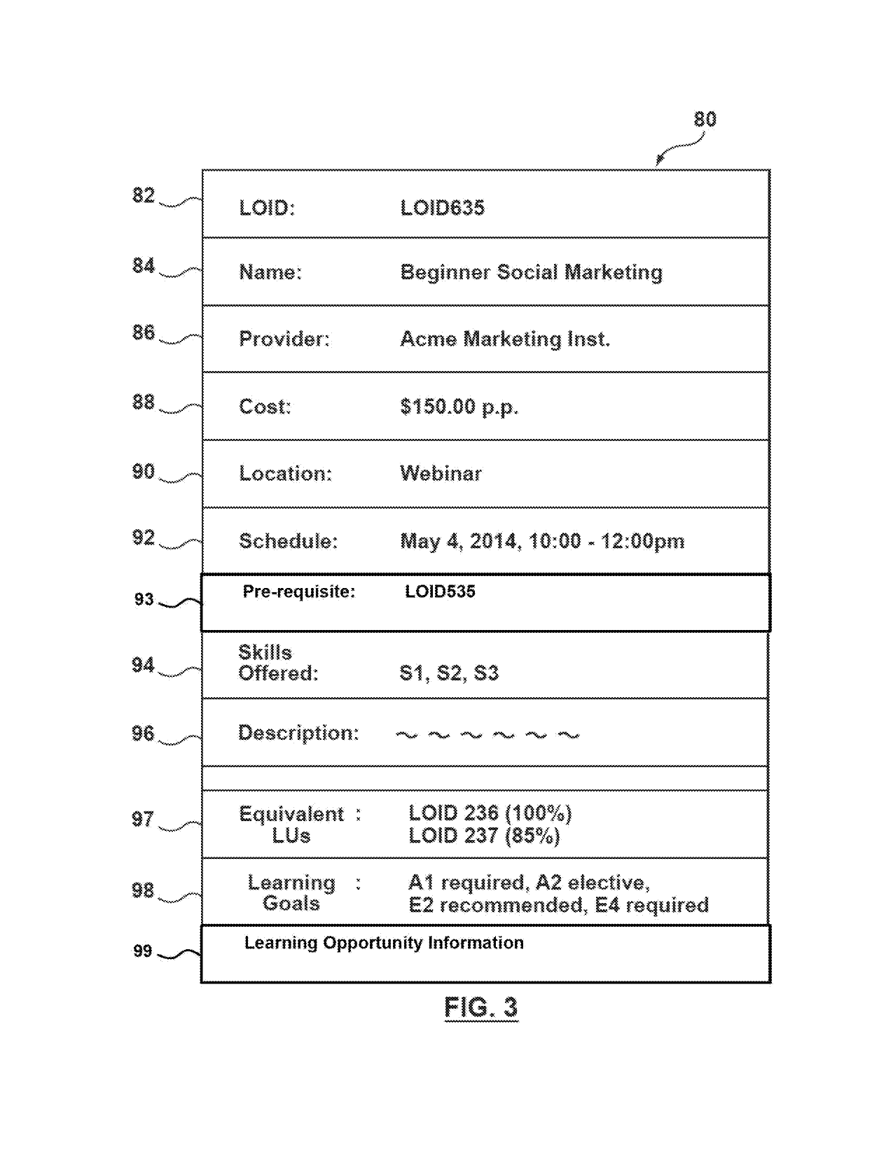

Referring now to FIG. 3, illustrated therein is an exemplary learning opportunity profile 80 that may be generated by one or more processors of the system 10 based upon the educational provider information received from one or more educational providers. The learning opportunity profile 80 as shown includes different types of information associated with the learning opportunity. It should be understood that in other cases, the types of information associated with the learning opportunity may differ.

The exemplary learning opportunity profile 80 includes a learning opportunity identifier 82 which is used for identifying the learning opportunity within the system 20. The learning opportunity profile 80 also includes a learning opportunity name 84, “Beginner Social Marketing”, indicative of the name of the course that being offered. The profile 80 also includes educational provider information 86 about the educational provider “Acme Marketing Institute” that is offering the course. The profile 80 also includes cost information 88, location information 90 and the scheduling information 92 associated with the learning opportunity.

The learning opportunity profile 80 also includes prerequisite information 93. The prerequisite information 93 indicates the skills, accreditations and/or other courses required and/or recommended prior to attending the associated learning opportunity. In the example as shown, the prerequisite information 93 indicates that LOID535 is necessary for this course. In another example, Beginner Social Marketing course may require “Introduction to Marketing” course. The “Introduction to Marketing” course may require a high-school diploma as a prerequisite.

The learning opportunity profile 80 also includes skills 94 that will be provided through the learning opportunity. The skills 94, as noted above, may be provided by the educational provider or extracted from the description of the learning opportunity through keyword analysis.

The learning opportunity profile 80 also includes a description 96. The description 96 is the description of the course, which, for example may be provided by the educational provider offering the course.

The learning opportunity profile 80 also includes learning goals 98 associated with the learning opportunity. The learning goals 80 are indicative of what the learner hopes to achieve through education. In some cases, a learning goal may be an employment position coveted by the learner. For example, a learner who is an engineer may wish to move into a role involving technical sales and marketing.

In some cases, a learning goal may be a certification, or another form of accreditation (e.g. formal recognition) from an accrediting institution. For example, a learner working as a financial analyst for an organization may wish to obtain an accounting certification such as a Certified Management Accountant or a Certified General Accountant. In some cases, a learning goal may not be associated with a job position or an accreditation program but be indicative of an area of learning of interest to the learner.

The learning goal information may be stored within the learning opportunity profile 80. For example, if a particular course is recommended for a job position by an employer, it may be noted as such. In another example, if the course is an elective or mandatory to achieve a particular certification, then it may be noted as such. In the example as shown, the course is associated with accreditation A1 as a required course. It is an elective to the accreditation A2. The course is also recommended for employment positions E1, E2 and E3 and a requirement for employment position E4.

The learning opportunity profile 80 may also include equivalent learning opportunity information 99 about other learning opportunities that are similar to the current learning opportunity. For example, there may be more than one course that provides one or more similar skills.

In some embodiments, information about equivalent learning opportunities may be provided by one or more users 14 of the system 10. For example, an educational provider who is providing a particular learning opportunity may wish to indicate that the learning opportunity is similar to one or more other learning opportunities. In another example, an accreditor may wish to indicate a plurality of courses that would qualify for a particular accreditation.

In some embodiments, the equivalent learning opportunities may be determined by the system 10. For example, the system 10 may be configured to determine whether two or more learning opportunities are similar by analysing the skills offered by the learning opportunities. In some cases, the system 10 may be configured to assign an equivalency value to indicate the equivalency of two courses. For example, an equivalency value of 100% may indicate that two courses are equivalent. However, an equivalency value of 50% may indicate that the two courses are only 50% equivalent. For example, the courses may only share 50% of the skills.

In some embodiments, if two courses are determined as equivalent, for example if a user 14 has indicated that they are equivalent or the system 10 has determined that they are equivalent above a certain equivalency value, then the courses may be noted on each other’s learning objective profile as being equivalent learning opportunities 99.

Referring back to FIG. 2, the modules 50 include an employer interface 60. The employer interface 60 is configured to receive employer information from one or more users 14 interacting with the system 10 as employers 62. The employers 62, for example, may include various employers in various industries.

The employer information may include biographical information about the employer 62. The employer information may also include one or more employment positions (i.e. employment opportunities) provided by one or more employers. The employment positions may be positions that are currently vacant, had been previously vacant and/or will be vacant in the future.

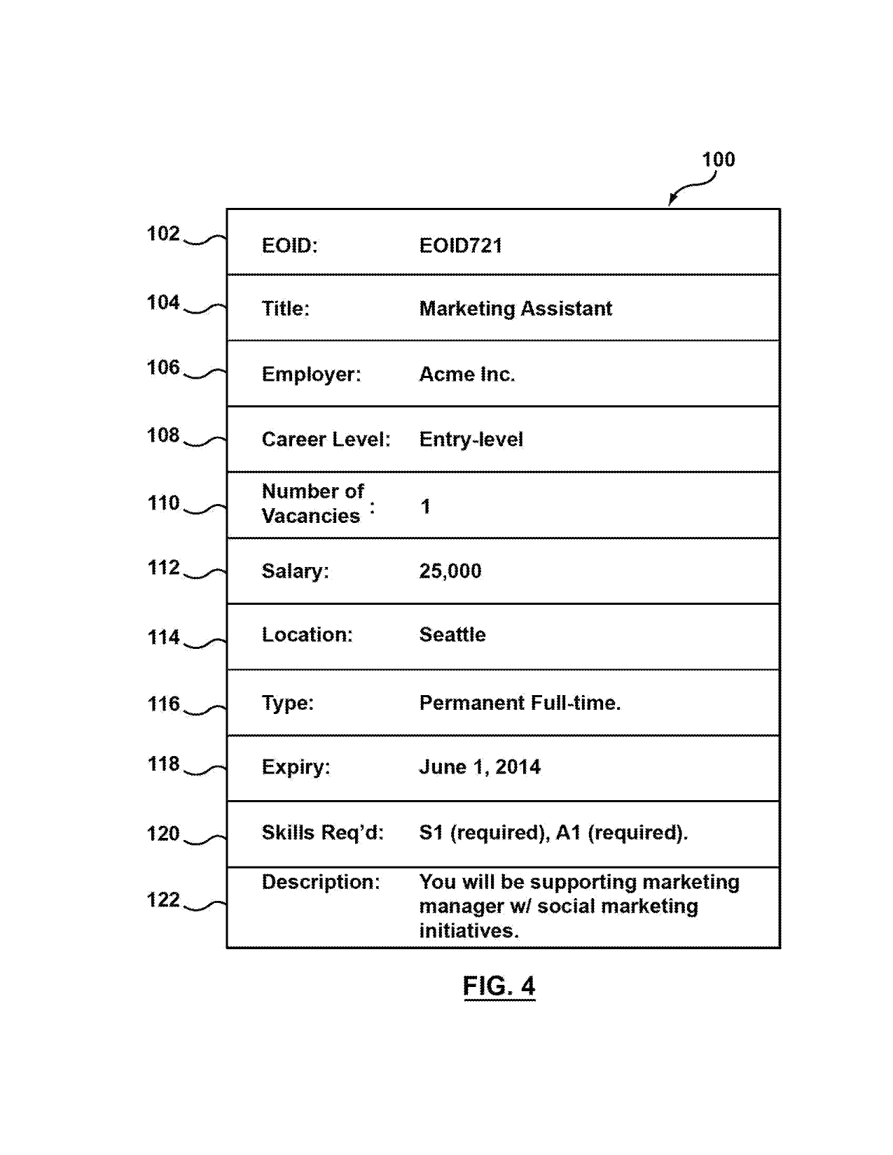

Referring now to FIG. 4, illustrated therein is an exemplary employment position profile 100 associated with one or more employment opportunities that may be generated by one or more processors of the system 10 based upon the employer information received from one or more employers 62. It should be understood various types of information associated with the employment position profile 100 as described below are provided herein for illustrative purposes. In other embodiments, the information included in the employment position profile 100 may differ.

The employment position profile 100 includes a position identifier 102 to identify the position within the system 10. The profile 100 also includes the title 104 of the employment position and an employer 106 associated with the position. The profile 100 also includes a “career-level” 108 indicative of the seniority level of the position. The career-level information 108 may allow the employer to indicate the experience level of the candidates they are hoping to receive. In the example as shown, the position is an “entry-level” position thus it could be inferred that candidates with little or no experience may be qualified for the position. In other cases, the career level 108 may include early to mid-level, mid-level, mid to senior level, senior/executive level to indicative that the employer is looking for progressively more senior candidates.

The employment position profile 100 also includes a number of vacancies information 110 associated with the position. The number of vacancies information may be indicative of how many employees the employer is planning to hire for the associated position. In the example as shown, the employer is looking for a single person for that position. In other cases, such as in a call centre, the employer may look to hire multiple people to fill the available positions.

The employment position profile 100 also includes a remuneration information 112 associated with the position, which in this case is an annual salary of $25,000. In many cases, the remuneration information 112 may not be necessarily included. That is, the employer may chose not to disclose the salary, or to provide a range for the salary.

The employment position profile 100 also includes a location 114 associated with the employment opportunity. The location 114 is indicative of where the job is located. In the case as shown, the job is located at a single location in Seattle. However, in other cases, there may be multiple locations where the job is available, or travel between multiple locations may be required. It is also possible for the job to be location independent. For example, it may be possible to do the job from anywhere.

The employment position profile 100 also includes a type 116 associated with the employment opportunity. The type 116 may indicate whether the position is permanent, part-time, full-time, contract, and so on.

The employment position profile 100 also includes an expiry date 118 indicative of when the employer will stop accepting applications for the position or when the position listing may be deactivated.

The employment position profile 100 also includes skills required 120 indicative of one or more skills or accreditations required or recommended for the position. The information about the skills required may be provided by the employer, extracted from a description associated with the position, or a combination of both. If the skills required are extracted from the description, a keyword extraction algorithm similar to the algorithm described above for extracting skills being offered by the learning opportunity may be employed.

The employment position profile 100 also includes a description 112 of the employment opportunity.

The employment position profile 100 may be generated based upon the information provided by one more employers. In some embodiments, the employment position profile 100 may be generated based upon the information obtained from other information sources. For example, the system 10 may be configured to obtain employment position information from other websites such as career websites or job posting websites. In some cases, the system 10 may access an employer’s website to obtain employment position opportunity information (instead of the employer accessing the system 10 to provide the employer information). This may allow the system to build up a robust database of employment positions.

In some embodiments, the employment position profiles 100 associated with the employment opportunities may be selected as learning goals for one or more of the learners. For example, if a learner is seeking a particular employment position, the learner may set the employment position profile associated with the employment position as a learning goal. The system 10 will then determine the skills/knowledge/accreditation necessary to qualify for the employment position and recommend courses that are available that provide the necessary skills/knowledge/accreditation. The process of determining required skills/knowledge/accreditation and recommending courses are described in further detail below.

Referring back to FIG. 2, the modules 50 include an accreditor interface 64. The accreditor interface 64 may be configured to receive accreditation information from one or more users 14 interacting with the system 10 as accreditation entities. The accreditation entities may include professional bodies (e.g. accounting, law, engineering, marketing). For example, Certified Management Accounting is an accreditation. The accreditation entities may also include employers who are acting as accreditation entities. For example, a large employer such as Microsoft Inc. may issue certification to professionals who had met certain standards (e.g. Microsoft™ certified professional in IT). The accreditation entities may also include traditional educational providers such as universities and colleges who may offer certificates, diplomas, or degrees in various topics of study. For example, a degree in computer science (B.Sc. Computer Science) is an accreditation.

The accreditation information associated with an accreditation may include information about the skills, competencies, or knowledge necessary to obtain the accreditation.

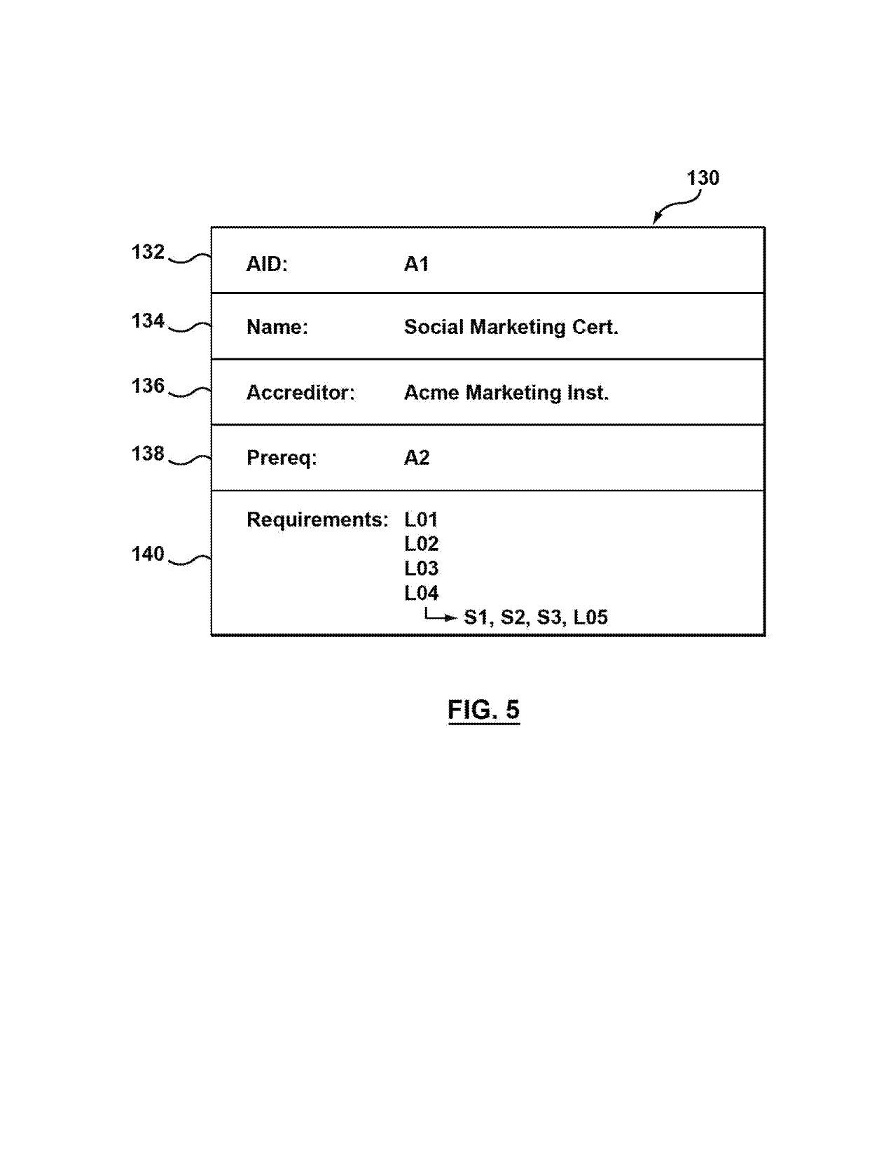

Referring now to FIG. 5, illustrated therein is an exemplary accreditation profile 130 associated with an accreditation that may be generated by one or more processors of the system 10 based upon the accreditation information received. It should be understood that various types of information associated with the accreditation profile 130 as described below are provided herein for illustrative purposes. In other embodiments, the information included in the accreditation profile 130 may differ.

The accreditation profile 130 includes an identifier number 132 to identify the accreditation within the system 10. The accreditation profile 130 includes a name 132 and Accreditation entity information 134.

The accreditation profile 130 also includes prerequisites 136. The prerequisites 136 are indicative of one or more recommended or required accreditation and/or courses prior to starting the process of obtaining the accreditation associated with the accreditation profile 130. The prerequisites 136 could be linked, when available, to corresponding accreditation profile or learning opportunity profile.

The accreditation profile 130 may also include one or more requirements 138. The requirements 138, for example, may include the courses 140 and or other requirements necessary to obtain the associated accreditation. The courses 140 could be linked, when available, to the learning opportunity profiles associated with the courses 140. This would permit a user to “drill-down” to obtain other courses or skills associated with the required courses. For example, the course L04 includes skills S1, S2, and S3 as well as the course L05.

Referring back to FIG. 2, the modules 50 include a learner interface 70 configured to receive learner information from one or more users 14 interacting with the system 10 as learners. The learners may include students, professionals, employees or any other suitable person that wishes to learn.

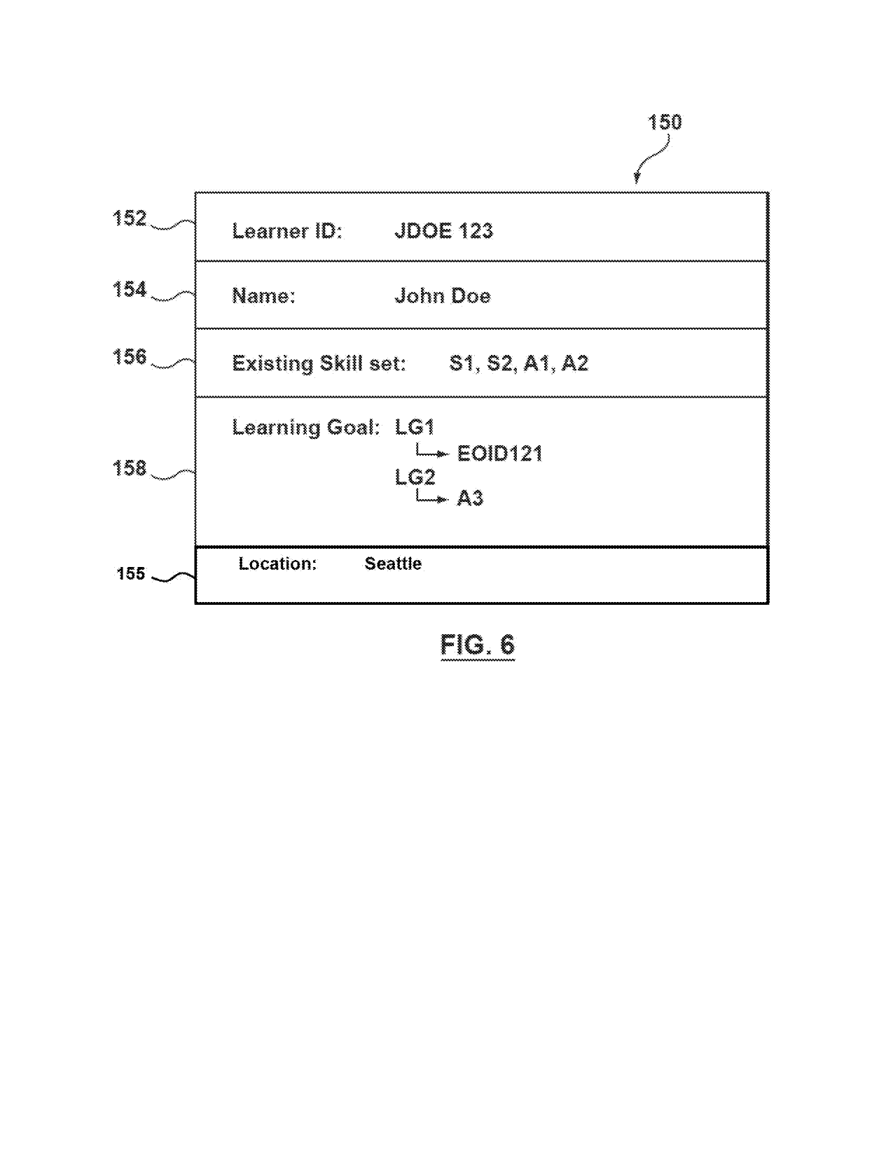

Referring now to FIG. 6, illustrated therein is an exemplary learner profile 150 associated with a learner that may be generated by one or more processors of the system 10 based upon the learner information received. It should be understood various types of information associated with the learner profile 150 as described below are provided herein for illustrative purposes. In other embodiments, the information included in the learner profile 150 may differ.

The learner profile 150 includes a learner identifier 152 to identify the learner within the system 10. The learner profile 150 also includes a name 154 associated with the learner. The learner profile 150 also includes a location 155 associated with the learner. The location could be indicative of a geographical location of the learner. In some cases there may be more than one location associated with the learner.

The learner profile 150 also includes an existing skill set 156 associated with the learner. The existing skill set may include skills, learning opportunities (i.e. courses) that the learner has completed, or one or more accreditations that the learner have obtained.

The learner profile 150 also includes one or more learning goals 158 associated with the learner. The learning goals could be a job position or an accreditation. In the example as shown, for Learning Goal 1 (LG1) indicated by reference numeral 160, the learner has selected a particular employment position with an identifier EOID121. For Learning Goal 2 (LG2) indicated by reference numeral 162, the learner has selected an accreditation with an identifier A3.

In some embodiments, the information could be retrieved from an existing social network (e.g. LinkedIn or Facebook)

As described above, the system 10 (and registry 53) stores information from various stakeholders (learners, educational providers, accreditation entities, and employers) in the educational space. This allows the system 10 to provide a centralized forum that is capable of servicing various stakeholders as described herein below.

A learning goal, as described above, may include a desired accreditation or an employment opportunity. In some embodiments, the system 10 is configured to generate a learning map associated with the learning goal. The learning map indicates the skills or learning opportunities required (or recommended) to qualify for the employment opportunity or an accreditation. The learning map may also include one or more learning opportunities that provide the noted skills.

The learning map is generated based upon learner profile associated with the learner and the employment opportunity profile or accreditation profile associated with the learning goals identified by the learner.

In some embodiments, the learning map is personalized based upon a learner’s existing skills, accreditation, completed learning opportunities and so on. That is, the learning map for a particular learner may indicate the learning opportunities that the learner need to complete in order to qualify for a learning goal. For example, the user may have already completed some of the requirements to achieve a particular learning goal. The learner will already completed some of the requirements. In that case, the learning map may include the learning opportunities that are needed in addition to the completed requirements to qualify for the learning goal.

The learning map could be generated, for example, by obtaining the requirements 120 associated with the employment position from the employment opportunity profile 100, and contrasting that information with the learner’s existing skillset 156 obtained from the learner profile 150. This will generate one or more skills and/or qualifications that the learner 72 need to obtain in order to qualify for the employment position. The system 10 could determine one or more learning opportunities that offer the needed skills and/or qualifications based upon the learning opportunity profiles and provide this information to the learner.

In some embodiments, the system 10 may be configured to provide information about desired learning opportunities that are within a defined distance from a learner. This could be determined based upon the location information stored for the learners and the learning opportunities. For example, the location 90 of the learning opportunity profile 80 and location 155 of the learner profile 150 could be used to determine a distance between the learner and the learning opportunity and determine whether that distance is within a defined distance. In some cases, the defined distance could be provided by the learner. In other cases, the defined distance could be set by the system 10.

In some embodiments, the system 10 is configured to provide information about equivalent courses to one or more users 14. This information, for example, may be determined based upon the equivalent learning objective information 99 stored for the learning opportunity profile 80.

For example, a learner may be interested in a particular learning opportunity. The system may then suggest one or more learning opportunities that may be equivalent to that learning opportunity. In another example, an educational provider may wish to inform one or more learners about equivalent learning opportunities being offered by the educational provider.

In some embodiments, the system 10 may be configured to determine a demand for one or more skills and/or learning opportunities. For example the system 10 may determine that there are a number of learners who are interested in a particular course from the learning goals/learning map associated with the learners. The demand information could be provided to one or more educational providers so that the educational providers may consider creating a new learning opportunity to service these learners.

In some embodiments, the system 10 may be configured to determine a demand for one or more skills and /or learning opportunities based upon a location. For example, there may be a number of learners that are interested in learning about social marketing at a given location (e.g. a city). However, the educational providers may not provide learning opportunities at the location. The demand information for the location could be provided to one or more educational providers so that the educational providers may consider creating one or more learning opportunities to service these learners.

In some embodiments, the system 10 is configured to dynamically update various aspects of the information stored within the system. That is, the system 10 is configured to let the participants of the learning network train the system such that learning goals and learning maps become more accurate over time.

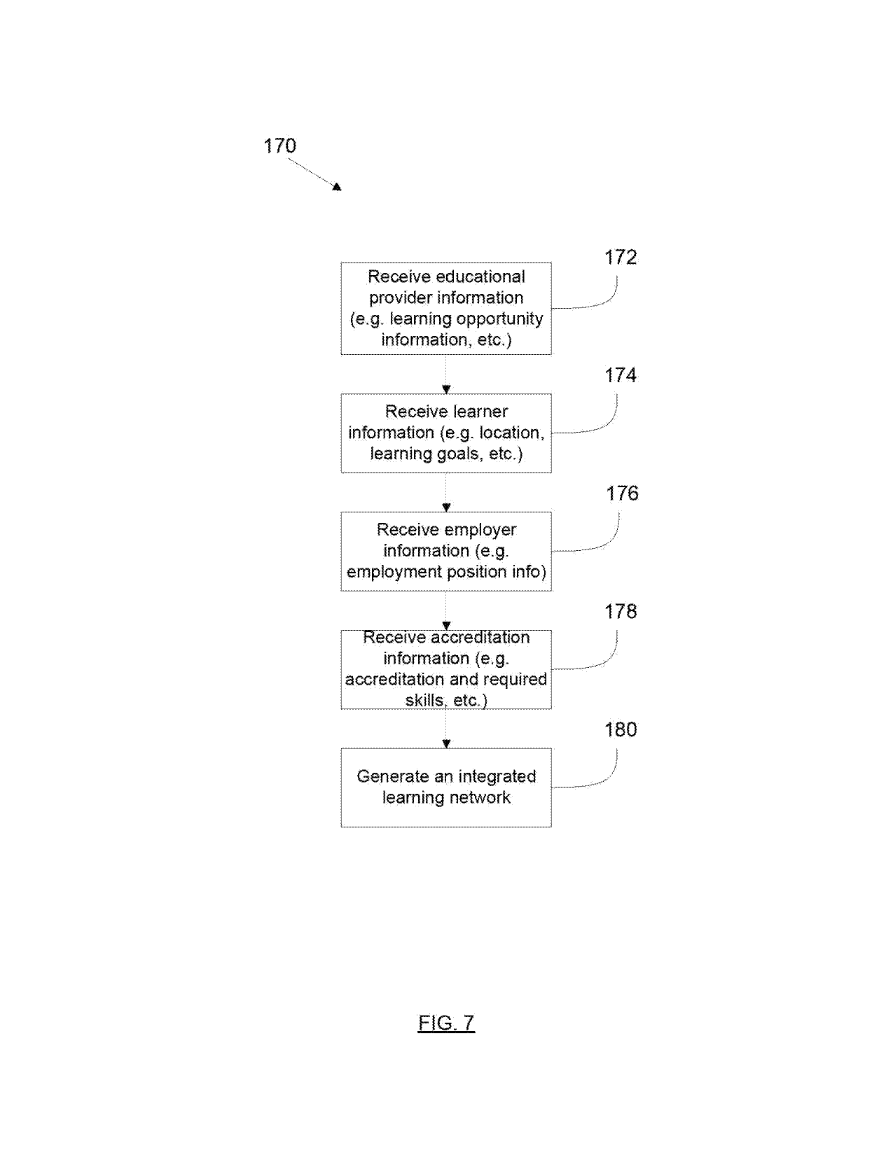

Referring now to FIG. 7, illustrated therein an example of a method 170 for providing educational information.

At step 172, educational-provider information is received. For example, the educational-provider information may include learning-opportunity information about various learning opportunities being offered by one or more educational providers, as well as other information pertaining to the educational providers.

At step 174, learner information is received. For example, the learner information may include the learner’s identity, the learner’s location, the learner’s learning goals, the learner’s existing skill set, etc.

At step 176, employer information is received. For example, the employer information may include biographical information about an employer. The employer information may also include one or more employment positions (i.e. employment opportunities) provided by one or more employers. The employment positions may be positions that are currently vacant, had been previously vacant, and/or will be vacant in the future.

At step178, accreditation information is received. For example, the accreditation information may include the accreditor’s identity, they type of accreditation provided by the accreditor, the courses that qualify for a particular accreditation, and information about the skills, competencies, or knowledge necessary to obtain an accreditation.

At step 180, the information received during the preceding steps 172-178 (education-provider information, learner information, employer information; and accreditation information) are used to generate an integrated learning network, as generally described and defined herein.

It should be understood that in other embodiments, one or more steps of the above-described methods may be modified. In particular, one or more of the steps may be omitted, executed in a different order and/or in parallel, and there may be additional steps.

It should be understood that even though the embodiments are described herein in relation to electronic learning systems, they may be applicable in other fields of technology.

While the above description provides examples of one or more apparatus, methods, or systems, it will be appreciated that other apparatus, methods, or systems may be within the scope of the present description as interpreted by one of skill in the art. Moreover, the scope of the claims appended hereto should not be limited by the embodiments set forth in the examples, but should be given the broadest interpretation consistent with the description as a whole.

1. An educational information system, the system comprising:
(a) at least one server;
(b) a plurality of computers in data communication with the at least one server, the computers being usable by educational providers, learners, employers and accreditors to connect to the server;
(c) wherein the server is configured to:
(i) receive educational provider information from the educational providers, the educational provider information for each of the educational providers including learning opportunity information associated with at least one learning opportunity;
(ii) receive learner information from the learners, the learner information for each of the learners including, location of the learner;
(iii) receive employer information from the employers, the employer information including employment position information;
(iv) receive accreditation information from the accreditors, the accreditation information including at least one accreditation and at least one skill required to earn the accreditation; and
(v) providing an integrated learning network based upon the received educational provider information, learner information, employer information and the accreditation information.

2. The system of claim 1, wherein the server is further configured to generate a learning goal.

3. The system of claim 2, wherein the learning goal is generated based upon information received from at least one of the learner, employer, accreditor, and the educational provider.

4. The system of claim 2, wherein the learner information from at least one of the learners include one of the learning goals selected by the learner.

5. The system of claim 2, wherein the server is further configured to generate at least one learning map based upon a learning goal, the learning map being indicative of one or more learning opportunities necessary to qualify for the learning goal.

6. The system of claim 4, wherein the server is further configured to generate a personalized learning map for at least one of the learners based upon the learner information received from the learner and a learning goal selected by the learner, the personalized learning map being indicative of one or more learning opportunities necessary for the learner to qualify for the learning goal.

7. The system of claim 4, wherein the server is further configured to recommend at least one learning opportunity based upon the learning goal selected by the learner.

8. The system of claim 7, wherein the server is further configured to recommend at least one learning opportunity based upon a geographical location associated with the learner and the learning opportunities.

9. The system of claim 1, wherein the server is configured to provide equivalency information about at least two of the learning opportunities.

10. The system of claim 9, wherein the server is configured to determine the equivalency information based upon the learning opportunity information associated with the learning opportunities.

11. The system of claim 9, wherein the equivalency information is received from at least one of the educational provider, learner, employer or accreditor.

12. The system of claim 1, where the server is configured to determine demand information indicative of a demand for at least one learning opportunity based upon the learner information.

13. The system of claim 12, wherein the demand information includes a geographical location associated with the demand.

14. A method for providing educational information, the method comprising:
(a) receiving educational provider information from educational providers, the educational provider information for each of the educational providers including learning opportunity information associated with at least one learning opportunity;
(b) receiving learner information from learners, the learner information for each of the learners including location of the learner and at least one learning goal selected by the learner;
(c) receiving employer information from employers, the employer information including employment position information;
(d) receiving accreditation information from accreditors, the accreditation information including at least one accreditation and at least one skill required to earn the accreditation; and
(e) generating an integrated learning network based upon the received educational provider information, learner information, employer information and the accreditation information.

15. A server for providing educational information, the server comprising at least one processor configured to:
(a) receive educational provider information from educational providers, the educational provider information for each of the educational providers including learning opportunity information associated with at least one learning opportunity;
(b) receive learner information from learners, the learner information for each of the learners including, location of the learner and at least one learning goals selected by the learner;
(c) receive employer information from employers, the employer information including employment position information;
(d) receive accreditation information from accreditors, the accreditation information including at least one accreditation and at least one skill required to earn the accreditation; and
(e) generating an integrated learning network based upon the received educational provider information, learner information, employer information and the accreditation information.
